(19) United States
(12) Patent Application Publication
(10) Pub. No.: US 2007/0199596 A1
(43) Pub. Date: Aug. 30, 2007

(54) DIGITAL PRESSURIZATION COMPOUND TERMINAL TG6000X

(76) Inventor: Manuel Fernandez, (US)

Correspondence Address: MANUEL FERNANDEZ, 811 SE 11TH AVENUE, DEERFIELD BEACH, FL, 33441, US

(21) Appl. No.: 11/550,306

(22) Filed: Feb. 6, 2007

Related U.S. Application Data
(60) Provisional application No. 60/596,744, filed on Oct. 18, 2005.

(51) Int. Cl. F16K 15/20; F16K 24/00; F16K 37/00

(52) U.S. Cl. 137/228

(57) ABSTRACT

A digital pressurization compound terminal comprising a high accuracy digital pressure gauge sheltered in a silicone housing, main body made of a high-resistance alloy and dimensioned with a handle to be held in the palm of the user's hand, o-ring, control or HP valves, ring, regulator assembly valve, equipped piston, second o-ring, inferior body and handle, third o-ring, male quick coupling, screw, regulator setting wheel, purging female quick coupling, service female quick coupling and on-off switch a LCD digital graphic screen, a barcode scanner, an infrared thermometer, a date and time module, a piloted regulator, a selector, a motherboard with a micro-controller, a backlight, a battery charger, a USB port, a pressure regulator, Skydrol compatibility, presets, 0.5% digital accuracy, 9 different measuring units, battery level display, mini/maxi pressure button, clear/zero out button, ergonomic design and embossed buttons, an 8-button keyboard, a 4 position-selector's lever and a pressure-relief safety valve.

This invention applies to and enhances the Digital Pressurization Compound Terminal patented under U.S. Pat. No. 6,935,359 B2 granted on Aug. 30, 2005 and provisional applications Ser. No. 11/171,514 and 60/596,744. It keeps all the functions of the patented version plus several innovations: an extra large LCD digital graphic screen, a barcode scanner, an infrared thermometer, a date and time module, a piloted regulator, a selector, a motherboard with a microcontroller, a backlight, a battery charger, a USB port, a pressure regulator, Skydrol compatibility, presets, 0.5% digital accuracy, 9 different measuring units, battery level display, mini/maxi pressure button, clear/zero out button, ergonomic design and embossed buttons.

Generality:

The Digital Pressurization Compound Terminal is mostly used for maintenance operations on hydraulic, oleo-pneumatic, and pneumatic circuits of aircrafts and helicopters, but can also be used for NASCAR or Racecar suspensions as well as for military armored vehicles.

This invention, which greatly improves the Digital Pressurization Compound Terminal already patented, allows the user to perform gas and hydraulic pressurization operations more quickly while recording the parameters. This ensures automatic traceability that is the number one criteria in quality control, and which is critical in the Aviation Industry.

Application Field:

Hydraulic, oleo-pneumatic and pneumatic pressurization of current and future generations of planes requires extreme precision and considers additional factors such as the temperature of the part to pressurize and barometric pressure.

A technician who needs to pressurize a part from a plane must consider its temperature. The compensated pressure is always defined at 20° C. (ISO standard). Up to now, a technician would have to take the landing gear temperature (as an example), consult a diagram provided by the aircraft builder and then pressurize according to the temperature. The pressure needed would be different depending on the location (Anchorage (−20° C.) or Miami (+30° C.))

Simultaneously, the technician would manually record on a piece of paper the different parameters such as the pressure before and after pressurization, temperature of the part, the plane identification, the name of the technician, date, time etc. . . . . Aside from a considerable loss of time, all these operations might be performed during the night or in bad weather conditions, leading to potential transcription errors that would in most cases damage the circuits, thereby jeopardizing the safety of the plane being maintained.

This new version of The Digital Pressurization Compound Terminal (TG6000X) allows the maintenance officer to automatically consider different parameters, memorize it and download it into a computer that is programmed adequately. This enables to store all the parameters in order to get traceability, analyze it and print it.

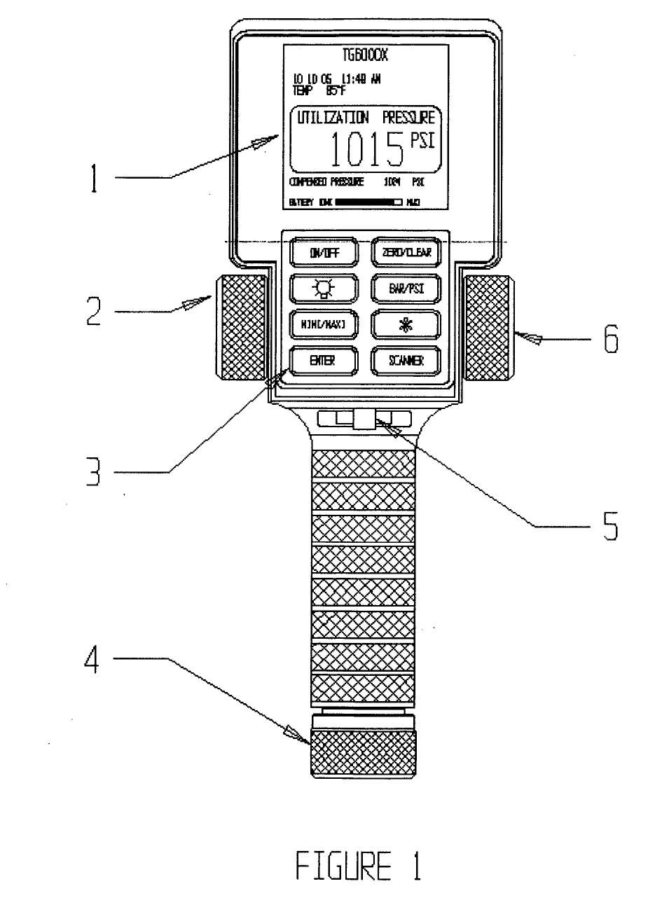

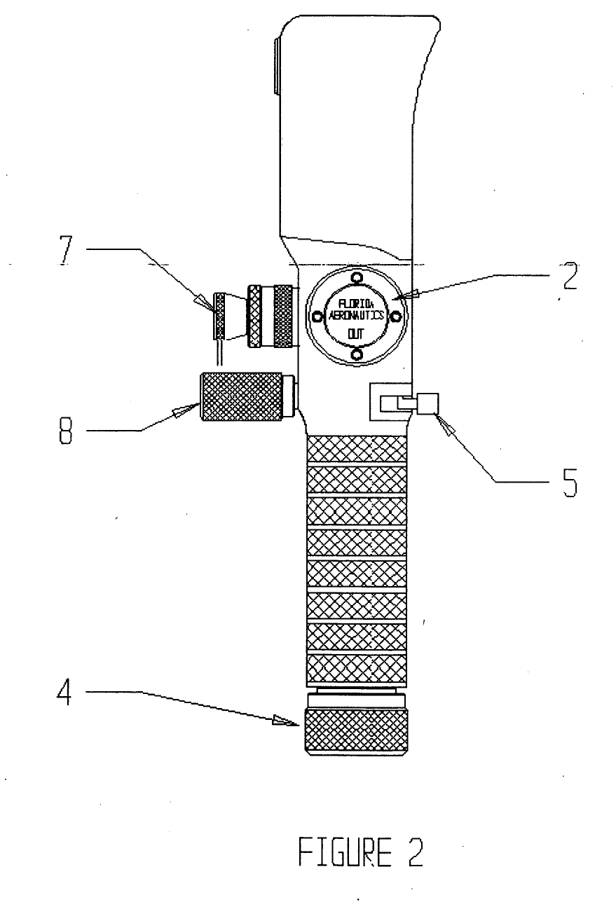

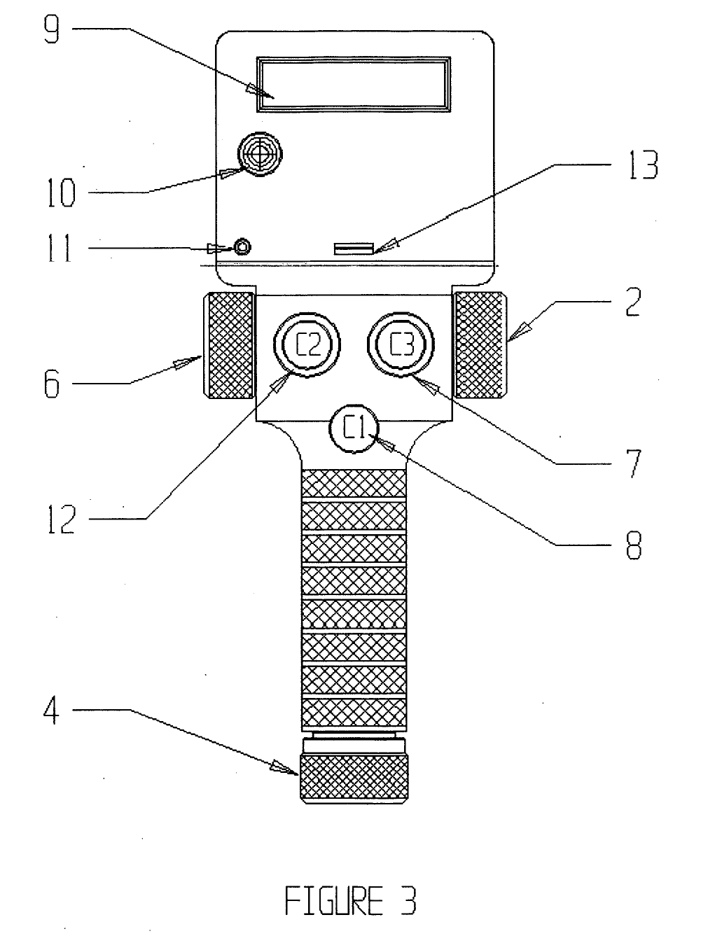

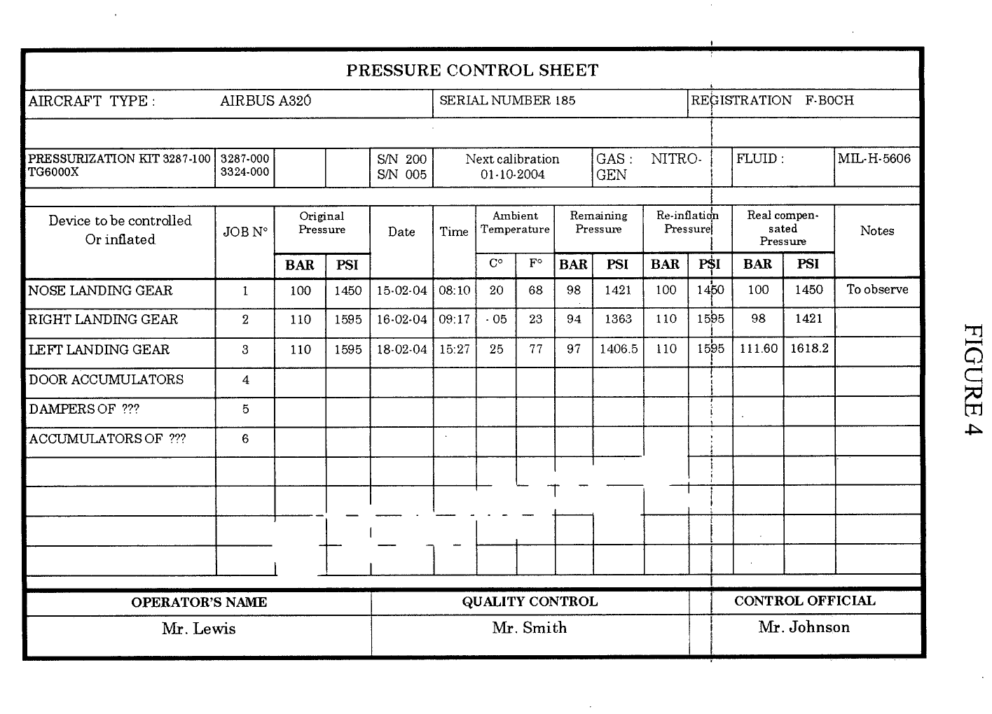

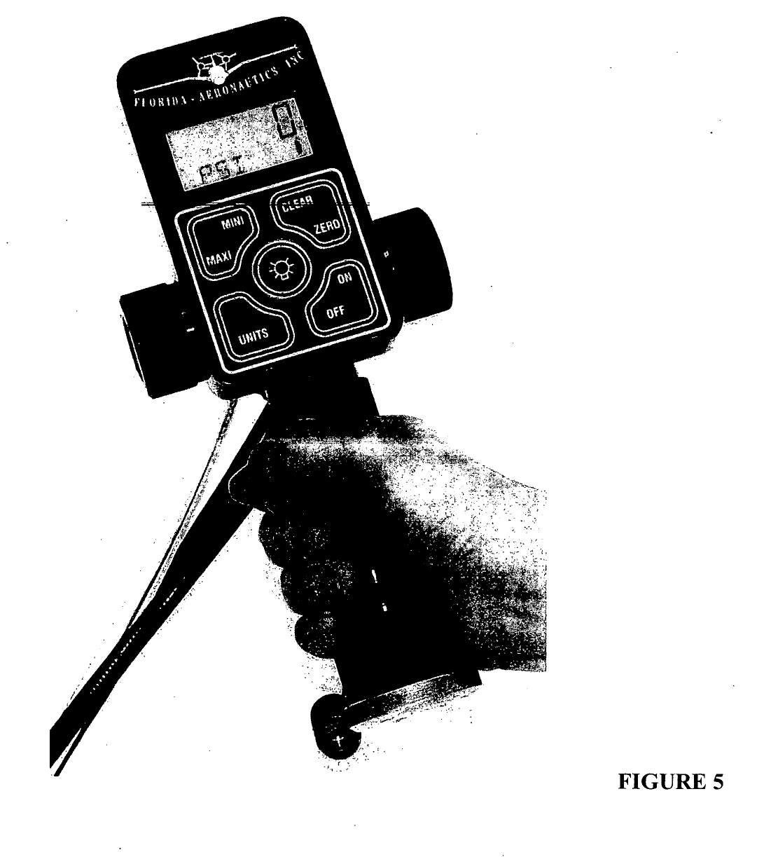

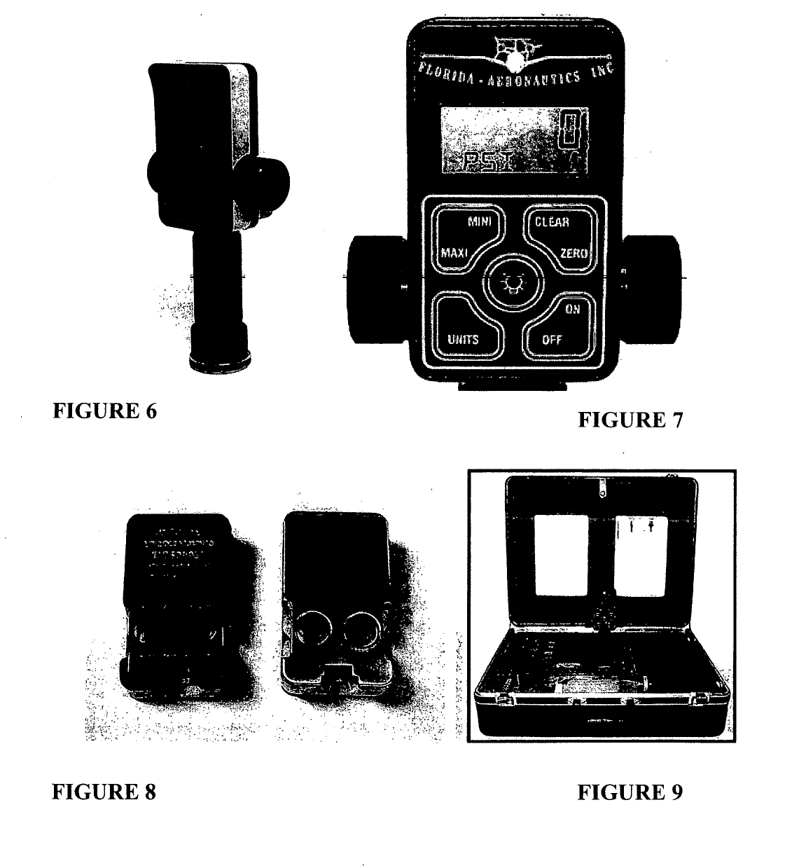

This new version allows the Digital Pressurization Compound Terminal already patented to automatically do the operations described in the application field and comprises 10 changes:
The digital pressure gauge has been replaced by a large graphic screen (LCD) (FIG. 1, #1)
A bar code scanner has been added (FIG. 3, #9)
An infrared temperature sensor has been added (FIG. 3, #10)
A date and time module has been added
A piloted regulator has been added (FIG. 1, #4)
A selector has been added (FIG. 1, #5)
A motherboard equipped with a microcontroller has been added
A backlight has been added allowing use of the terminal at night
A battery charger has been added (FIG. 3, #11) to recharge the battery
A USB port has been added to download the data on a computer (FIG. 3, #13)
   Composition of the Kit:

Just like the old version of the Digital Pressurization Compound Terminal, the TG6000X is delivered in an adapted case with hoses equipped with quick couplings, a safety nitrogen tank adaptor, plus different interface adaptors for the plane equipment requiring maintenance.

### DESCRIPTION

(1) The new version of the Digital Pressurization Compound Terminal TG6000X is now cast in one piece (FIG. 1) and is equipped with a large graphic screen (LCD) (#1) which makes it much easier to read the data the operator must know such as:
   Pressure source
   Pre-regulated pressure
   Residual pressure in the landing gear
   Inflated pressure
   A scrolling compensated pressure
   Temperature
   Date and time of the operation
   Battery charge level
   Data red by the scanner.
   Behind the graphic screen is the motherboard equipped with a microcontroller and a memory chip to manage the different functions and store the information.
(2) An 8-button keyboard is located under the graphic screen to operate the Digital Pressurization Compound Terminal TG6000X (#3)
(3) The 4 position-selector's lever is located under the keyboard displaying the following information on the screen (#5):
   Position 1: pressure of the nitrogen source
   Position 2: pressure pre-selected by the regulator
   Position 3: residual or inflated pressure in the part needing pressurization
   Position 4: depressurization of the Digital Pressurization Compound Terminal TG6000X after utilization and before unplugging it from the source.

The unit is equipped with a handle allowing the user to carry the Terminal. Inside this handle is the regulator (#4) that is now controlled by the pressure source and replaces the spring regulator of the old version of the Digital Pressurization Compound Terminal.

The valves V1 and V2 (FIGS. 1 and 3, #6 and #2) and the quick couplings C1, C2 and C3 (FIG. 3, #7, #8, #12) present in the previous version of the Digital Pressurization Compound Terminal have been kept.

Use:

When a pressurization operation is to be performed on a hydraulic, pneumatic or oleo-pneumatic part of a plane, the technician has the choice between performing the task manually, like it was done with the old version of the Digital Pressurization Compound Terminal, and doing it with the assistance of a computer like it is done with this new version.

Given that this new invention not only allows you to perform pressurization operations, pressure control and hydraulic filling and also enables the follow up of the traceability for the Quality Control, it will be necessary to install identification barcode stickers on each pneumatic or oleo-pneumatic part of the plane that will need maintenance operations, as well as on the plane. The maintenance technician will also wear a pin with a barcode indicating his name or other appropriate identification.

To perform and memorize a maintenance operation, called a “JOB”, we will do the actions in the following order:
(1) Connect the TG6000X to a nitrogen tank or other nitrogen source
(2) Activate the TG6000X pressing on the ON button
(3) Follow the instructions prompted on the screen such as
   Scan plane barcode: Aim the scanner of the TG6000X at the barcode sticker on the plane in order to enter its identification,
   Scan organ's barcode: Aim the scanner at the landing gear (or other part) to be pressurized. This action enables us to identify the part in needs of maintenance, and it will also memorize its temperature. Since the infrared temperature sensor automatically takes the temperature of the object being scanned, we will have to provide a distinctive barcode for the TG6000X to recognize that the plane's part temperature is the one to consider and memorize.
   Scan technician barcode: Then the maintenance technician will identify himself by aiming the scanner at his barcode pin.

The TG6000X will not be active until all of these actions are completed. Once the TG6000X is connected to the nitrogen source, and after the nitrogen tank valve is opened, the technician will manipulate the selector to verify
The pressure of the nitrogen source
The pressure which he had pre-selected with the regulator
The residual or inflated pressure in the part that needs to be maintained.

Each pressure measurement can be memorized by pressing the ENTER key. All the previously scanned information as well as the time and date will automatically be considered.

Both the temperature of the part that needs to be pressurized and the barometric pressure that is stored at the time of the first scanning will be automatically considered by the microprocessor of the TG6000X so that the pressure sent is automatically adjusted in relation to the original ISO pressure 20° C. The pressure that needs to be added will appear in big font on the screen, and the real pressure added in accordance to the temperature (compensated pressure) will appear in small font just below.

Before unplugging the hose that connects the TG6000X to the nitrogen source and to the part being maintained, the technician will have to depressurize the entirety with the fourth position of the selector.

The maintenance officer will perform up to 100 jobs and will be able to transfer the different jobs into a computer at any time through a software program provided with the kit. This software, set up in the computer that has a Windows-based system, will download all the parameters stored for each job in a specially designed chart (drawing 4)

All the jobs will be stored and printed, allowing complete traceability. The software will automatically analyze the data and underline frequent re-pressurizations of the same organ.

What is claimed is:

1. A digital pressurization compound terminal device, said device comprising a handle having an upper end and a lower end; means for automatically regulating and adjusting pressure; a carter body installed on the upper end of said handle, said carter body having a first valve for controlling the distribution of a working gas or fluid toward the equipment being serviced and a second valve for depressurizing the equipment; and a first quick coupling orifice for connecting a purging hose having a check valve; a second quick coupling orifice for connecting a hose that is used for depressurizing and filling up the equipment.

2. A device as recited in claim 1, further comprising a regulator assembly valve and piston disposed inside said handle.

3. A device as recited in claim 1, further comprising a quick male coupling for connecting a hose used for receiving incoming fluid or gas.

4. A device as recited in claim 1, further comprising an extra large LCD digital graphic screen, a barcode scanner, an infrared thermometer, a data and time module, a piloted regulator, a selector, a motherboard with a micro-controller, a backlight, a battery charger, a USB port, a pressure regulator, Skydrol compatibility, presets, 0.5% digital accuracy, 9 different measuring units, battery level display, mini/maxi pressure button, clear/zero out button, ergonomics design and embossed buttons, an 8-button keyboard, a 4 position-selector's lever and a pressure-relief safety valve.
